(19) United States
(12) Patent Application Publication
(10) Pub. No.: US 2008/0079994 A1
(43) Pub. Date: Apr. 3, 2008

(54) IMAGE FORMING APPARATUS AND COMPUTER PROGRAM PRODUCT

(75) Inventors: Hideo UENO, Nagoya-shi (JP); Masashi SUZUKI, Nagoya-shi (JP); Hiroshi KOIE, Nagoya-shi (JP); Kazunari TAKI, Nagoya-shi (JP); Takahiro IKENO, Seto-shi (JP); Takahiro HOSOKAWA, Nagoya-shi (JP)

Correspondence Address: BANNER & WITCOFF, LTD.;ATTORNEYS FOR CLIENT NOS. 0166889, 006760, 1100 13th STREET, N.W., SUITE 1200, WASHINGTON, DC, 20005-4051, US

(73) Assignee: BROTHER KOGYO KABUSHIKI KAISHA, Nagoya-shi (JP)

(21) Appl. No.: 11/862,246

(22) Filed: Sep. 27, 2007

(30) Foreign Application Priority Data
Sep. 28, 2006 (JP) 2006-265322

(51) Int. Cl. G06F 3/12

(52) U.S. Cl. 358/1.15

(57) ABSTRACT

An image forming apparatus includes a data processing unit that processes source data to generate image data, an image forming unit that forms an image, based on the image data generated by the data processing apparatus, on a recording medium equipped with a non-contact tag, and a data recording unit that records data associated with the image data on the non-contact tag.

### CROSS-REFERENCE TO RELATED APPLICATION

This application claims priority from Japanese Patent Application No. 2006-265322, filed on Sep. 28, 2006, the entire subject matter of which is incorporated herein by reference.

### TECHNICAL FIELD

Aspects of the present invention relate to an image forming apparatus including an image forming unit that forms an image on a recording medium and can record data on a non-contact tag attached to the recording medium, and to a program therefor.

### BACKGROUND

A non-contact tag such as a Radio Frequency Identification tag (RFID tag) is attached to (or also embedded in) a recording medium such as a sheet. An image is formed on such recording medium and at the same time, data is recorded on the non-contact tag. For example, JP-A-2005-197835 discloses that when an image is formed on a sheet based on image data, the image data is recorded on the non-contact tag attached to the sheet in order to utilize the original image data in a subsequent copying.

The original image data may be simply recorded on a non-contact tag. However, when a user desires to edit and re-use the image formed on the recording medium, such a method of recording data may cause an inconvenience that the image cannot be edited. Aspects of the present invention relate to the above-problem. According to at least one aspect of the present invention, an image forming apparatus may be provided that forms an image on a recording medium and records data related to (associated with) the image on a non-contact tag attached to the recording medium, thereby facilitating editing the image formed on the recording medium.

According to an aspect of the present invention, an image forming apparatus including a data processing unit that processes source data to generate image data, an image forming unit that forms an image, based on the image data generated by the data processing unit, on a recording medium equipped with a non-contact tag, and a data recording unit that records data associated with the image data on the non-contact tag.

### BRIEF DESCRIPTION OF THE DRAWINGS

In the accompanying drawings:

FIG. 1 is a block diagram showing the configuration of an image forming apparatus according to an embodiment of the present invention;

FIG. 2 is a schematic cross-sectional view showing the internal configuration of a printer in the image forming apparatus;

FIG. 3 is an explanatory view showing the configuration of a sheet equipped with a non-contact tag;

FIG. 4 is a flowchart showing a printing control process to be executed by a PC in the image forming apparatus;

FIG. 5 is a flowchart showing a relevant data write printing process in the printing control process;

FIG. 6 is a flowchart showing a specified data write printing process in the printing control process;

FIG. 7 is a flowchart showing a normal printing process in the printing control process;

FIG. 8 is a flowchart showing a version printing process in the printing control process;

FIG. 9 is a flowchart showing a data transmission process in the printing control process;

FIG. 10 is a flowchart showing a printer printing process to be executed by the printer; and

FIG. 11 is a flowchart showing a tag data read process to be executed by the printer.

### DETAILED DESCRIPTION

[Overall Configuration of the Embodiment]

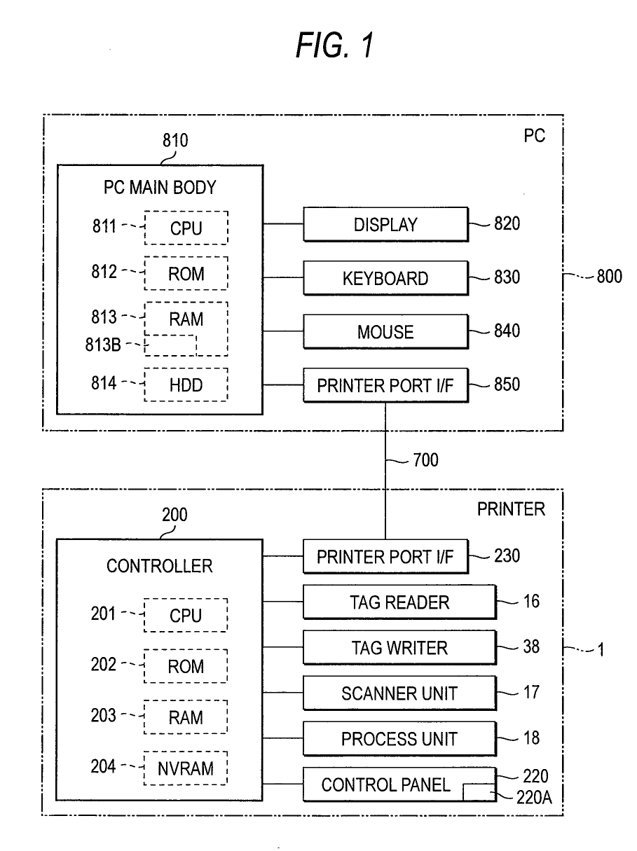

Next, embodiments of the present invention will be described below with reference to the accompanying drawings. FIG. 1 is a block diagram showing the configuration of an image forming apparatus according to an embodiment of the present invention. As shown in FIG. 1, the image forming apparatus of this embodiment includes a printer 1 serving as a main image forming apparatus and a personal computer (hereinafter simply referred to as PC) 800 serving as an upper device connected to the printer 1 via a cable 700. Note that the printer 1 and PC 800 may be connected via an intranet LAN or the Internet.

[Description of the Configuration of the Printer 1]

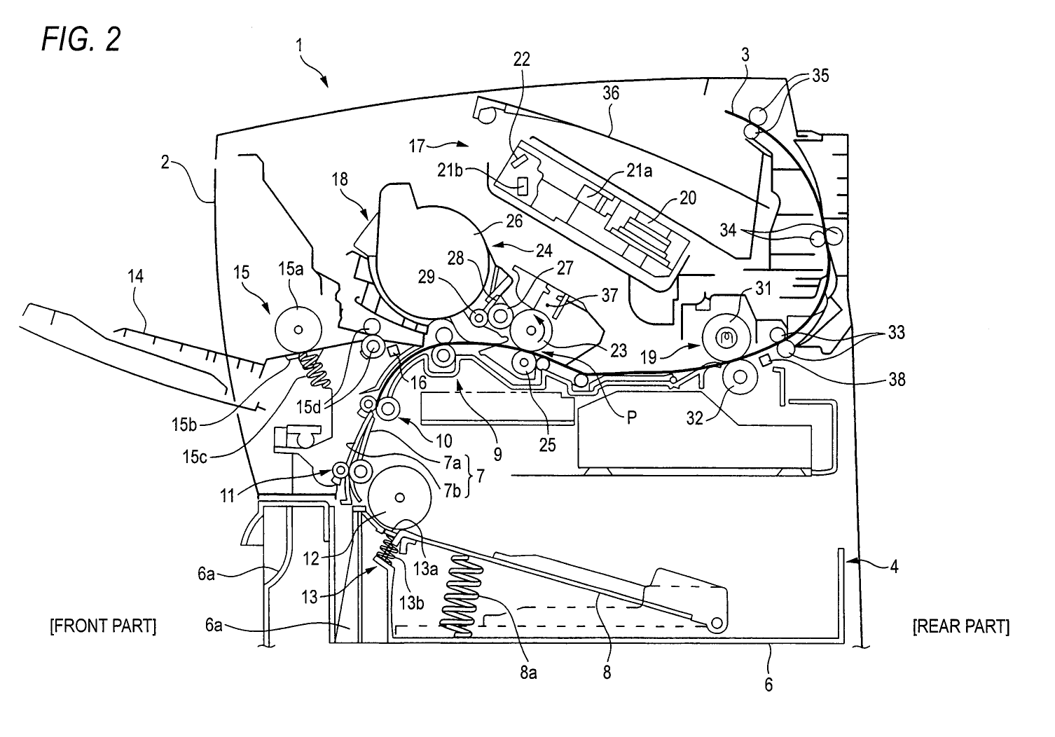

FIG. 2 is a schematic cross-sectional view showing the internal configuration of the printer 1. As shown in FIG. 2, within a main body case 2, the printer 1 includes a feeder part 4 for feeding sheet 3 serving as a recording medium; a multi-purpose tray 14; a process unit 18 as an example of an image forming unit for forming an image on the fed sheet 3; and a fixing unit 19. Note that in the printer 1, the side on which the multi-purpose tray 14 is mounted in the main body case 2 (the left side in FIG. 2) is hereinafter referred to as the “front part,” while the side opposite on which the multi-purpose tray 14 is mounted in the main body case 2 is referred to as the “rear part.”

[Description of the Configuration of the Feeder Part 4]

As shown in FIG. 2, in the bottom part of the main body case 2, the feeder part 4 includes a detachable sheet teed tray 6, a sheet retainer plate 8 provided in the sheet feed tray 6, a feed roller 12 provided above an end of the sheet feed tray 6, and a separation pad 13. In addition, there is provided a curved teed path 7 from the feed roller 12 to an image forming position P (or a contact part between a photosensitive drum 23 and a transfer roller 25, i.e., a transfer position at which a toner image on the photosensitive drum 23 is transferred onto the sheet 3).

The sheet retainer plate 8, which can retain the sheets 3 stacked in layers, is pivotably supported at the distal end part relative to the feed roller 12, thereby the proximal end part is allowed to move up and down. The sheet retainer plate 8 is upwardly energized by a spring 8a on its back. The separation pad 13 is disposed to oppose the feed roller 12, so that a pad 13a composed of a member having a high friction coefficient is pushed against the feed roller 12 by a spring 13b.

On the other hand, the feed path 7 is formed in a curved shape by a pair of guide plates 7a and 7b for guiding the sheet 3. In addition, there are disposed at appropriate intervals on the feed path 7 sequentially from the upstream of the sheet feed direction, the feed roller 12; a pair of feed rollers 11 including a pair of a drive roller and a follower roller; a pair of feed rollers 10 including a pair of a drive roller and a follower roller; and a pair of registration rollers 9 including a pair of a drive roller and a follower roller disposed immediately before the image forming position P.

In the feeder part 4 configured as described above, the topmost sheet 3 of those stacked in layers on the sheet retainer plate 8 is pushed against the feed roller 12, and sandwiched between the feed roller 12 and the separation pad 13 by the feed roller 12 being rotated, thereby sheets are fed one by one. The thus fed sheet 3 is also fed by the feed rollers 11, and then sequentially by the feed rollers 10 and the registration rollers 9 to the image forming position P with a predetermined timing.

[Description of the Configuration of the Multi-Purpose Tray 14]

On the front part side of the main body case 2 above the feeder part 4, there are disposed the multi-purpose tray 14 which serves to supply the sheets 3 manually or automatically and a multi-purpose side sheet feed mechanism 15 for feeding the sheets 3 stacked in layers on the multi-purpose tray 14. The multi-purpose side sheet feed mechanism 15 includes a feed roller for the multi-purpose tray 15a and a multi-purpose side sheet feed pad 15b, and allows the multi-purpose side sheet feed pad 15b to be pushed against the feed roller for the multi-purpose tray 15a by a spring 15c disposed on the back of the multi-purpose side sheet feed pad 15b. In addition, the multi-purpose side sheet feed mechanism 15 includes a pair of feed rollers 15d including a pair of drive roller and a follower roller.

In the multi-purpose tray 14 configured as described above, the sheets 3 stacked in layers on the multi-purpose tray 14 are sandwiched between the feed roller for the multi-purpose tray 15a being rotated and the multi-purpose side sheet feed pad 15b, and then fed one by one to the registration rollers 9 via a pair of feed rollers 15d.

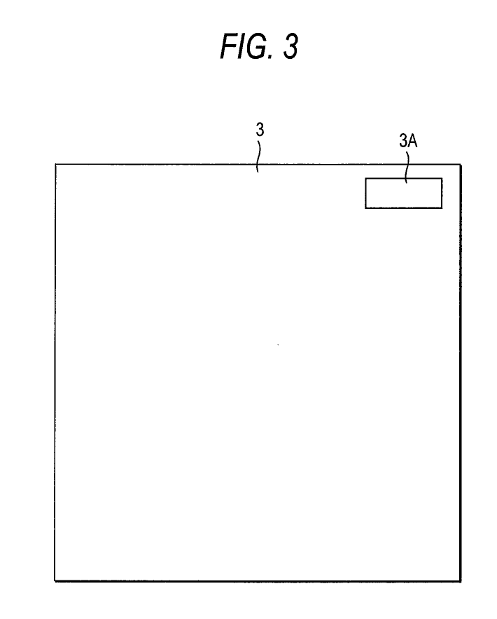

There is also disposed a tag reader 16 serving as data reading unit between the feed rollers 15d, 10 and the registration rollers 9. When the sheet 3 as shown in FIG. 3 having a Radio Frequency Identification Tag (RFID tag: hereinafter simply referred to as the tag) 3A as an example of anon-contact tag is used, the tag reader 16 reads data recorded on the tag 3A. Consequently, while the sheet 3 equipped with the tag 3A is transported from the sheet feed tray 6 or the multi-purpose tray 14 to the image forming position P, the tag reader 16 can read data from the tag 3A attached to the sheet 3. Note that when data is read from (read out from) the tag 3A attached to the sheet 3 held in the multi-purpose tray 14, it is not always necessary to read (read out) the data by the tag reader 16 while the sheet 3 is being fed. For example, with the sheet 3 being held (placed) in the multi-purpose tray 14, the data may be read (read out) from the tag 3A attached to the sheet 3 by the tag reader 16.

[Description of the Configuration of a Scanner Unit 17]

The scanner unit 17 is disposed under a sheet discharging tray 36 in the upper part of the main body case 2, and includes a laser emitting part (not shown), a rotatably driven polygon mirror 20, lenses 21a and 21b, and a reflection mirror 22. The laser emitting part emits a laser beam and the laser beam is passing through or reflected from the polygon mirror 20, the lens 21a, the reflection mirror 22, and the lens 21b so that the scanner unit 17 allows a laser beam to illuminate and quickly scan across the surface of the photosensitive drum 23 of the process unit 18.

[Description of the Configuration of the Process Unit 18]

The process unit 18 includes the photosensitive drum 23 serving as an electrostatic latent image carrier, a scorotron type electrifier 37, a drum cartridge having the transfer roller 25 or the like, and a developing cartridge 24 detachably attached to the drum cartridge. The developing cartridge 24 includes a toner accommodating part 26, a developing roller 27, a layer thickness restricting blade 28, and a toner supply roller 29.

The toner accommodating part 26 is filled with positively charged non-magnetic one-composition polymeric toner as a developer. The toner is supplied by the toner supply roller 29 to the developing roller 27, at the time of which the toner is positively charged by friction between the toner supply roller 29 and the developing roller 27. Furthermore, the toner supplied onto the developing roller 27 is carried on the developing roller 27 in a thin layer of a uniform thickness by the layer thickness restricting blade 28 as the developing roller 27 rotates. On the other hand, the rotating photosensitive drum 23 is disposed opposite the developing roller 27, with the drum body being grounded and its surface being formed of a positively charged organic photosensitive material.

The scorotron type electrifier 37 is disposed above the photosensitive drum 23 with a predetermined gap therebetween so as not to be in contact with the photosensitive drum 23. The scorotron type electrifier 37 is a positively charging scorotron type electrifier which generates corona discharge from an electrifying wire such as of tungsten, and is designed to positively electrify the surface of the photosensitive drum 23 uniformly.

Then, as the photosensitive drum 23 rotates, the surface of the photosensitive drum 23 is first uniformly and positively charged by the scorotron type electrifier 37, and thereafter exposed to the laser beam from the scanner unit 17 during a quick scan, thereby an electrostatic latent image is formed based on the image data.

Subsequently, as the developing roller 27 rotates, the positively charged toner carried on the developing roller 27 is brought into contact with the photosensitive drum 23. At this time, the toner is supplied onto the electrostatic latent image formed on the surface of the photosensitive drum 23, i.e., onto the exposed part having a reduced potential due to the exposure to the laser beam on the uniformly and positively charged surface of the photosensitive drum 23. Thus, the toner is selectively carried to visualize the image, thereby a toner image is formed.

The transfer roller 25 is disposed below the photosensitive drum 23 to oppose the photosensitive drum 23, and supported rotatably in the clockwise direction in FIG. 2 in the drum cartridge. The transfer roller 25 is configured such that a metal roller shaft is coated with a roller formed of an ionic conductive rubber material, and receives a transfer bias (forward transfer bias) applied thereto from a transfer bias application power supply during transfer. Consequently, the toner image carried on the surface of the photosensitive drum 23 is transferred onto the sheet 3 at the above-described image forming position P while the sheet 3 is passing through between the photosensitive drum 23 and the transfer roller 25.

[Description of the Configuration of the Fixing Unit 19]

As shown in FIG. 2, the fixing unit 19 is disposed to the right of the process unit 18 downstream of the feed direction, and includes one heating roller 31, a pressure roller 32 disposed to push against the heating roller 31, and a pair of feed rollers 33 provided downstream of them. The heating roller 31, which is formed of a metal such as aluminum and includes a heater such as a halogen lamp for heating, allows the toner transferred to the sheet 3 in the process unit 28 to be thermally fixed while the sheet 3 passes through between the heating roller 31 and the pressure roller 32. Thereafter, the sheet 3 is fed by the feed rollers 33 into the discharging path in the rear side part of the main body case 2, and then further fed by feed rollers 34 and discharge rollers 35. Subsequently, the sheet 3 is discharged onto the sheet discharging tray 36. That is, various rollers from the feed roller 12, the feed roller for the multi-purpose tray 15a to the discharge rollers 35 serves as a transferring unit.

There is also disposed a tag writer 38, or an example of the data recording unit capable of recording data on the tag 3A, on a sheet conveying path between the heating roller 31 or the pressure roller 32 and the conveying rollers 33, 33. Thus, when the sheet 3 attached with the tag 3A is utilized, desired data can be recorded on the tag 3A of the sheet 3 after an image is formed thereon.

[Description of the Control System of the Printer 1]

In addition, on the upper surface of the printer 11 there is provided an operation panel 220 including various types of buttons (not shown) such as a tag reading button 220A and a liquid crystal display (not shown). Referring back to FIG. 1, the operation panel 220 is connected to a controller 200 in conjunction with the process unit 18, the scanner unit 17, the tag writer 38, and the tag reader 16. The controller 200 is configured as a microcomputer including a CPU 201, a ROM 202, a RAM 203, and a NVRAM 204 in which stored contents will not be erased even when the power supply switch is turned OFF. In addition, the controller 200 is connected to the PC 800 via a printer port interface (printer port I/F) 230 and the cable 700.

A PC main body 810 of a PC 800 includes a CPU 811, a ROM 812, a RAM 813, and a hard disk drive (HDD) 814. Here, the RAM 813 includes a tag write data area 813A and a print data area 813B, to be discussed later. Additionally, the PC main body 810 is connected with a display 820 such as a CRT, a keyboard 830, a mouse 840, and a printer port interface (printer port I/F) 850 for connecting to a controller 200 of the printer 1.

[Processing in the Control System (Processing in the PC 800)]

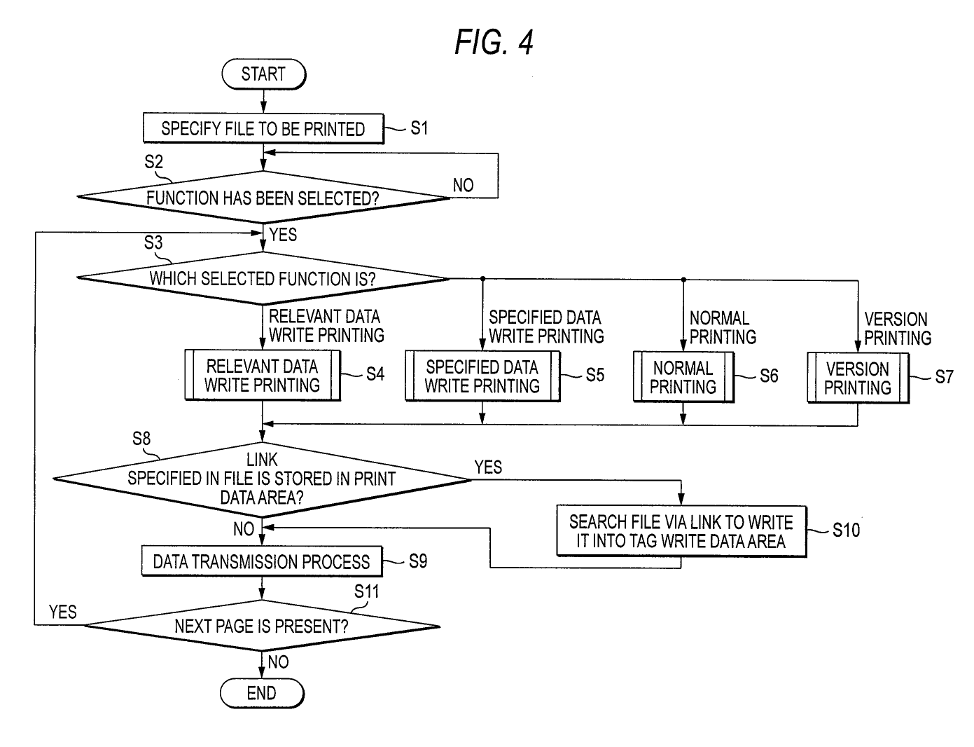

Now, description will be made for the processing in this control system. FIG. 4 is a flowchart showing a printing control process to be executed by the PC 800. Note that this process is initiated by the PC 800 executing various types of applications to create a file as source data of image data and then by the CPU 811 executing a predetermined program stored in the HDD 814.

As shown in FIG. 4, when the process is started, first in S1 (hereinafter S stands for a step), a file as source data of image data to be printed is specified. In S2 that follows, it is determined whether the user has finished selecting a function. The process waits in S2 until a function has been selected (S2; N).

That is, at the start of this process, a predetermined user interface is displayed on the display 820, prompting the user to select any desired function of “relevant data write printing,” “specified data write printing,” “normal printing,” or “version printing.” This is why the process waits in S2 until a function is selected.

When a function is selected (S2: Y), then the process proceeds to S3, where the selected function is determined. Then, depending on the selected function, one of the relevant data write printing (S4), the specified data write printing (S5), the normal printing (S6), and the version printing (S7) is executed. Note that these processes will be described in more detail later.

After one of the processes in S4 to S7 has been executed, the process proceeds to S8, where it is determined whether a link specified in the file is stored within the print data area 813B. As will be discussed later, when any one of the processes of S4 to S7 is executed, the print file specified in S1 is expanded as print data and written into the print data area 813B. Thus, in S8, it is determined whether the link specified by the file is stored in the written print data. For example, it is determined whether a link placed in any portion of a document file prepared by a word processing software (application) such as Microsoft Word® is present. More specifically, for example, the link may be in the form of “http:// . . . ” for designating a web side on the Internet or “file:// . . . ” for designating a storage position on the HDD 814 of the PC 800.

When no link (S8: N) is present, the process proceeds to S9. When a link (S8: Y) is present, then the file specified by the link is searched in S10 and written into the tag write data area 813A. Thereafter, the process proceeds to S9. In S9, the data having been written in the tag write data area 813A or the print data area 813B through the previous processes is sent to the printer 1 in a data transmission process. In S11, it is determined whether a data for next page is present. When a next page of data is present (S11: Y), then the process proceeds to S3, where the processes are repeated. When all the pages have been printed and thus no data for next page is present (S11: N), then the process once ends.

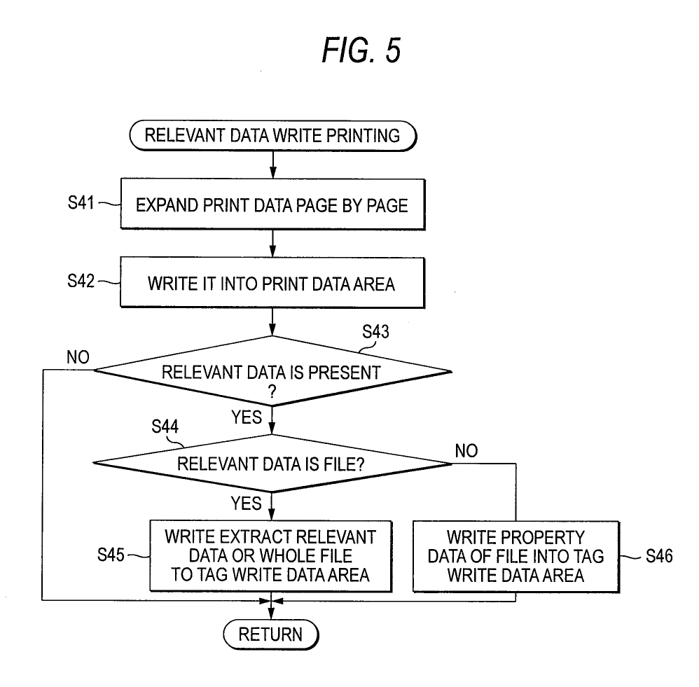

Now, FIG. 5 is a flowchart showing the relevant data write printing process of s4 in detail. In this process, first in S41, the print data corresponding to the file specified in S1 is expanded page by page. In S42 that follows, the print data is written into the print data area 813B. In S43, it is determined whether relevant data is present.

As used herein, the term “relevant data” means data corresponding to data which is pre-set in a table for each application corresponding to a file. For example, in a case of an application such as Microsoft Excel® for performing calculations in tabular form and presenting data in graphical form, such data (numerical values or mark having some information) used for forming graphs, performing calculations in tabular form, or forming an image in tabular form is set as the relevant data. The relevant data may also include various types of comments attached to the file, such as “Notes” in presentation data creation software (application) such as Microsoft PowerPoint® or those comments attached to photographic data taken by a digital camera or the like. The comment is editable by a user. The relevant data may include a property such as photographing conditions (e.g., Exif information, generating condition), which is embedded in photographic data. The property is not editable by a user. Furthermore, even when another sheet or file is present in the same folder, the other sheet or file is set as the relevant data.

When it is determined in S43 that relevant data is not present (S43: N), then the process proceeds to S8 mentioned above. When it is determined that the relevant data is present (S43: Y), it is determined in S44 whether the relevant data is in a file format. When the relevant data is in a file format (S44: Y), then the process proceeds to S45, where the relevant data extracted from the file or when the relevant data cannot be extracted therefrom, the whole file is written into the tag write data area 813A. Then, the process proceeds to S8 mentioned above. On the other hand, when the relevant data is not in a file format (S44: N), for example, when the relevant data is property data such as photographing conditions (typically Exif information) embedded in photographic data, the process proceeds to S46. In S46, the property data of the file specified in S1 (such as photographic data) is written into the tag write data area 813A, and then the process proceeds to S8 mentioned above.

As described above, in the relevant data write printing process (S4), the file specified in S1 is expanded as print data and then written into the print data area 813B (S41 and S42). At the same time, when the relevant data is present (S43. Y), then the relevant data is written into the tag write data area 813A. Additionally, when the printing is to be carried out on a plurality of pages (S11: N), the process of S4 will be repeatedly executed for the number of the pages. When relevant data for each page (S43: Y) is present, the relevant data is written into the tag write data area 813A (S45 and S46).

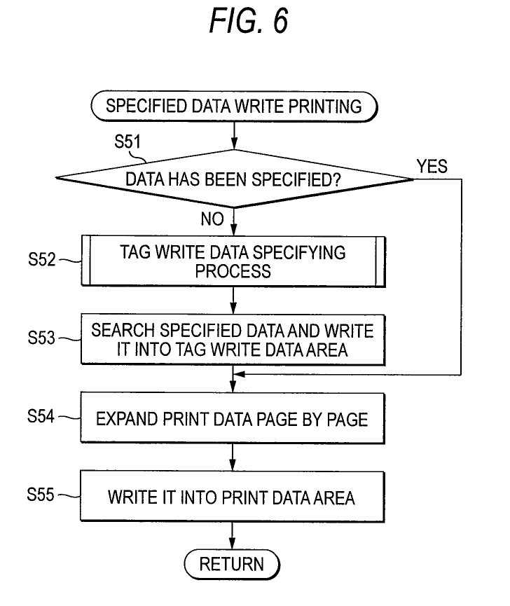

FIG. 6 is a flowchart showing the specified data write printing process of S5 in detail. In this process, first in S51, it is determined whether data has already been specified through this specified data write printing process. When the process proceeds to S5 for the first time, data has not yet been specified (S51: N). Thus, the process proceeds to S52.

In S52, the data to be written onto the tag is specified according to a user's input on the keyboard 830 or the mouse 840. To specify the data, individual file may be specified. In addition, a plurality of files may be specified, or those files within the same folder (i.e., at the same location) may be collectively specified (along with the lower-level files in the folder when the folder is present at the same location). Additionally, in this process, the location of the file specified in S1 may be displayed on the display 820 as a default, thereby facilitating referring to the same location and the same folder. Note that data to be specified may include, e.g., referable data that is referable during browsing and editing using an application associated with the specified file mentioned above.

In S53, the data specified in S52 is searched and then written into the tag write data area 813A. In S54, the print data corresponding to the file specified in S1 is expanded page by page. Furthermore, in S55, the print data is written into the print data area 813B, and then the process proceeds to S8 mentioned above. Note that when the print data includes a plurality of pages (S11: N), the process of S5 will be repeatedly executed for the number of the pages. In this case, it is determined in S51 that the data has already been specified (S51: N), and then only the print data is expanded page by page (S54) and the print data is written into the print data area 813B (S55).

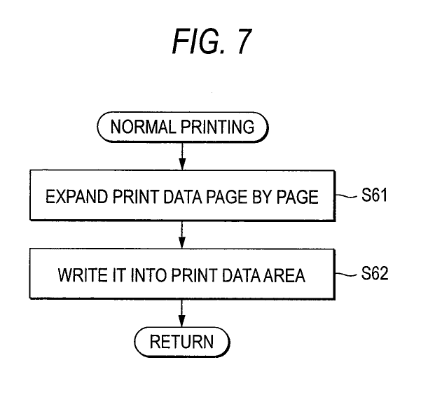

FIG. 7 is a flowchart showing the normal printing process of S6 in detail. In this process, as in S41 and S42 or S54 and S55 mentioned above, only the print data is expanded page by page (S61) and the print data is written into the print data area 813B (S62). Then, the process proceeds to S8 mentioned above.

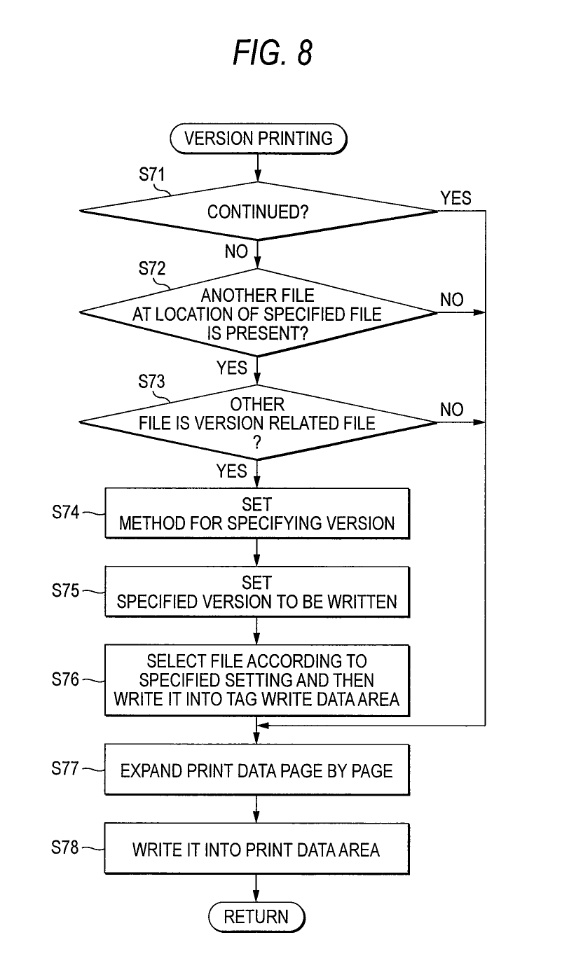

FIG. 8 is a flowchart showing the version printing process of S7 in detail. In this process, first in S71, it is determined whether the version printing process has already been executed and the process is continued to be carried out. When the process proceeds to S7 for the first time, the process is not continued to be carried out (S71: N), and thus the process proceeds to S72.

In S72, it is determined whether another file at the location of the file specified in S1 is present (e.g., within the same folder). When another file is present (S72: Y), then in S73, it is determined whether the file is a version related file. For example, in the determination, files having the same filename with different time stamps or those having the same character string and a numeric character in their filenames under the version control with the numeric character, are determined as the version related file.

When a version related file is present (S73: Y), then the process proceeds to S74, where a method for specifying a version is set according to a user's input on the keyboard 830 or the mouse 840. That is, as the method for specifying the version, it may be conceivable to specify the version using a time stamp or a filename, i.e., the numeric character in the filename. In this example, a time stamp is used as a default for the method for specifying the version. Note that a file of an application form which is blank and a file of the application form which is filled may be treated as version related files.

In S75, the specified version to be written onto the tag 3A is set. Here, the specified version may include various versions such as only the latest version, only the oldest version, the whole versions, or only a counter version. Note that the counter version means the oldest version when the file specified in S1 is the latest version whereas referring to the latest version when the file specified in S1 is the oldest version. Furthermore, when the file specified in S1 is a version other than the latest and oldest ones, the counter version includes the latest version. In S76, the corresponding files are selected and then written into the tag write data area 813A according to the specified version in S74 and S75. In S77 and S78, as in S41 and S42 or S54 and S55 mentioned above, the print data is expanded page by page (S77) and the print data is written into the print data area 813B (S78). Then, the process proceeds to S8 mentioned above.

On the other hand, when no version related file at the position of the file specified in S1 is present (S72: N or S73: N), then without executing the processes of S74 to S76, the process directly proceeds to S77, where only the print data is expanded page by page (S77) and the print data is written (S78). Additionally, when the print data includes a plurality of pages (S11: N), the process of S7 will be repeatedly executed for the number of the pages. In this case, it is determined in S71 that the process is continued (S71: Y), and only the print data is expanded page by page (S77) and the print data is written (S78).

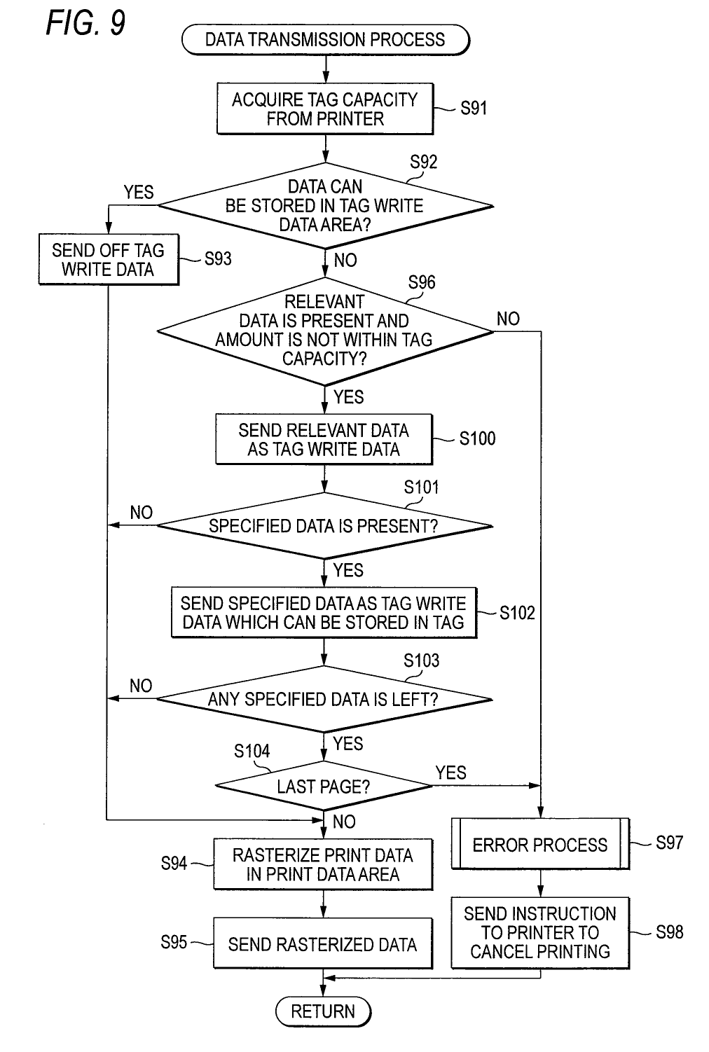

Now, referring to the flowchart of FIG. 9, detailed description will be made for the data transmission process of S9 in which the data having been written through each of the processes into the tag write data area 813A and the print data area 813B is sent to the printer 1.

In this process, first in S91, the storage capacity of the tag 3A is acquired from the printer 1. That is, at the time at which the sheet 3 is conveyed before a registration roller 9, the controller 200 of the printer 1 can acquire the storage capacity of the tag 3A via the tag reader 16. Thus, in S91, the PC main body 810 communicates with the controller 200, thereby acquiring the storage capacity of the tag 3A. Note that when the storage capacity of the tag 3A has been set in the specification and its value is stored in a predetermined area such as the HDD 814, the value is read in this step.

In S92, it is determined whether the data having been written into the tag write data area 813A can be stored in the tag 3A. When it can be stored in the tag 3A (S92: Y), then the process proceeds to S93, where all the data in the tag write data area 813A is sent to the printer 1 as tag write data to be written onto the tag 3A, and then the process proceeds to S94. In S94, a page of print data in the print data area 813B is rasterized. In S95 that follows, the rasterized data (an example of image data) is sent to the printer 1, and thereafter, the process proceeds to S11 mentioned above.

On the other hand, when all the tag write data can not be stored in the tag 3A (S92: N), then the process proceeds to S96, where it is determined whether relevant data is present and the amount of relevant data is within the storage capacity of the tag 3A. Each sheet 3 on which a print image is formed needs to be stored respectively associated relevant data. Thus, when the relevant data is present and the amount thereof is not within the storage capacity of the tag 3A (S96: N), then a known error process is performed in S97, e.g., to issue an alarm. Thereafter, the process sends an instruction to cancel the printing (image formation) to the printer 1 in S98, and then the process proceeds to S11 mentioned above.

Additionally, when all the tag write data can not be stored in the tag 3A (S92: N), relevant data is present and the amount of the relevant data is within the storage capacity of the tag 3A (S96: Y), then the process proceeds to S100. In S100, when the relevant data written into the tag write data area 813A is present, the relevant data is sent to the printer 1 as the tag write data. When relevant data is not present, the process also proceeds to S100 (S96: Y).

In S101, it is determined whether the specified data has been written in the tag write data area 813A. When the specified data has not been written (S101: N), the process proceeds to S94 mentioned above. When the specified data has been written (S101: Y), the process proceeds to S102. Note that the data written in the tag write data area 813B in the version printing (S7) can also be referred to as specified data.

In S102, the specified data by an amount which can be stored in the tag 3A is sent to the printer 1 as tag write data. That is, in the case of relevant data, the relevant data related to the print data (image data) to be printed page by page is written into the tag 3A of the respective sheet 3 (the same is applicable for a link). However, the specified data can be divided and attached to a plurality of sheets 3. Thus, when the specified data can not be stored in one tag 3A, only an amount of specified data corresponding to the storage capacity of the tag 3A is sent. Note that the specified data may be divided, when it is possible, into individual data units, but when it is not possible, may be divided into file units. In S103, it is determined whether specified data that has not yet been sent is left after the transmission in S102. When no data is left (S103: N), the process proceeds to S94 mentioned above.

On the other hand, when the specified data is left (S103: Y), then in S104, it is determined whether the sheet 3 is the last page in that printing job. When it is not the last page (S104: N), the process proceeds to S94 mentioned above. When it is the last page (S104; Y), the process proceeds to S97 mentioned above. That is, when the sheet 3 is not the last page (S104: N), then the subsequent specified data can be written onto the tag SA attached to the following sheet 3, and thus rasterized data is sent (S95). However, when it is determined that the sheet 3 is the last page (S104: Y) and thus no subsequent sheet 3 is available, then such processing could not be performed. Thus, an error process (S97) is executed.

[Process in the Control System (Process in the Printer 1)]

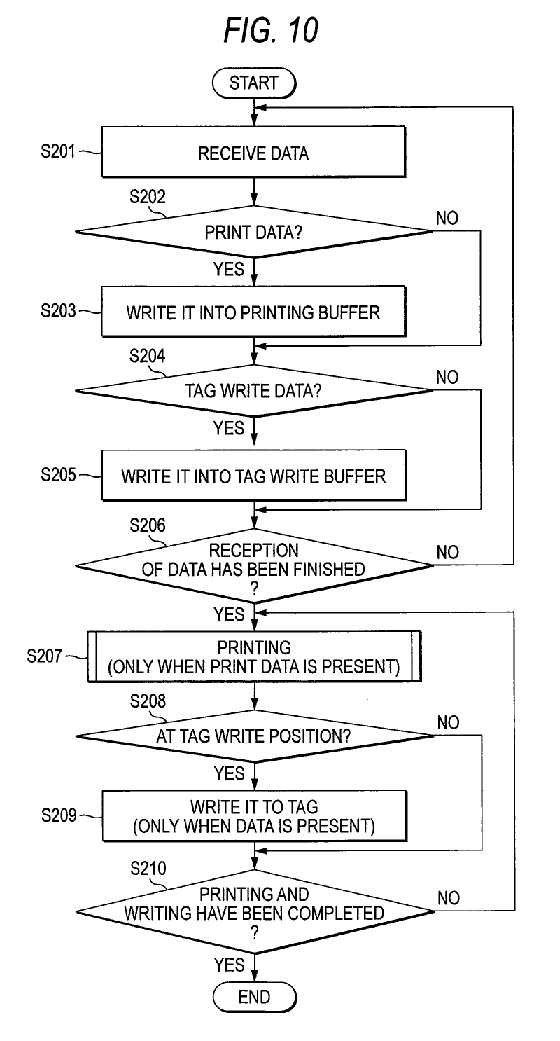

Now, FIG. 10 is a flowchart showing a printer printing process to be executed by the controller 200 of the printer 1 in response to the data transmission process (S9). This process is started when data is sent from the PC 800.

As shown in FIG. 10, when the process is started, then first in S201, the data sent from the PC 800 is received. In S202, it is determined whether the received data is print data. When it is print data (S202: Y), then in S203, the print data is written into a printing buffer in the RAM 203. Thereafter, the process proceeds to S204. When it is not print data (S202: N), the process proceeds to S204.

In S204, it is determined whether the received data is tag write data. When it is tag write data (S204: Y), then in S205, the tag write data is written into a tag write buffer in the RAM 203. Thereafter, the process proceeds to S206. When it is not tag write data (S204: N), the process proceeds to S206. In S206, it is determined whether the data from the PC 800 has been completely received. When the data was not completely received (S206: N), the process proceeds to S201, so that the processes of S201 to S205 mentioned above will be repeated.

On the other hand, when the data has been completely received from the PC 800 (S206: Y), then the process proceeds to S207. In S207, print data, only when the print data is present, starts to be printed on the sheet 3 by driving the scanner unit 17, the process unit 18 and the like in accordance with the print data. In S208, it is determined whether the sheet 3 has been conveyed to the tag write position at which the tag writer 38 can write data onto the tag 3A. When it is not at the tag write position (S208: N), the process proceeds to S210. When it is at the tag write position (S208: Y), then in S209, tag write data, only when the tag write data is present, is written onto the tag 3A, and thereafter, the process proceeds to S210.

In S210, it is determined whether printing of data on the sheet 3 and writing of data on the tag 3A were completed. When not completed yet (S210: N), the process proceeds to S207, so that the processes of S207 to S209 mentioned above will be repeated. When the printing onto the sheet 3 and the writing onto the tag 3A are completed (S210: Y), then the process once ends.

Furthermore, the controller 200 executes the following tag data read process when it has received from the PC 800 a command for reading data on the tag 3A or when the tag read button 220A of the control panel 220 is pressed.

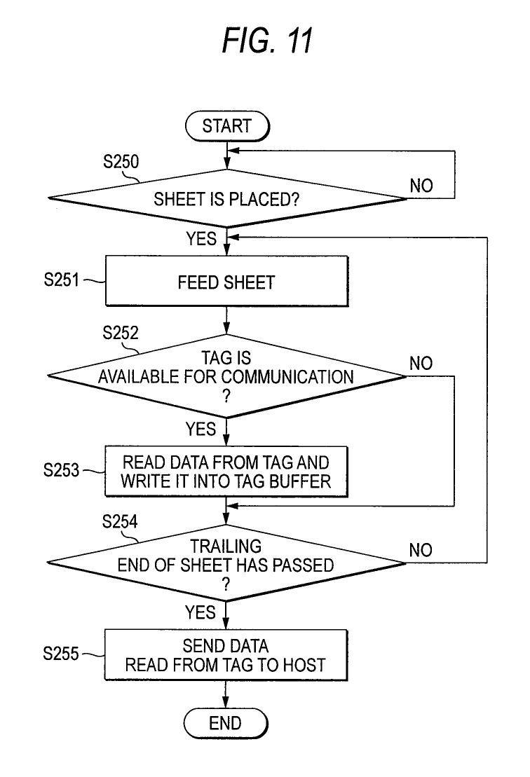

FIG. 11 is a flowchart showing the tag data read process. As shown in FIG. 11, when the process is started, it is first determined in S250 whether the sheet 3 is placed in the multi-purpose tray 14. When the sheet 3 has not been placed (S250: N), the process waits as it is in S250. When the sheet 3 has been placed (S250: Y), then in S251, the sheet 3 starts to be conveyed.

In S252 that follows, it is determined whether the tag reader 16 can communicate with the tag 3A. When the communication is not available (S252: N), the process proceeds to S254. When the communication is available (S252: Y), then in S253, data is read from the tag 3A via the tag reader 16 and written into the tag buffer in the RAM 203. Thereafter, the process proceeds to S254. In S254, it is determined whether the trailing end of the sheet 3 has passed so that the sheet 3 is discharged onto the sheet discharging tray 36. When the trailing end of the sheet has not passed (S254: N), the process proceeds to S251 mentioned above, so that the processes of S251 to S253 will be repeated. When the trailing end of the sheet has passed (S254: Y), the process proceeds to S255.

In S255, the data read from the tag 3A in S253 is sent to the host (in this case, the PC 800), and then the process ends. The data in the tag 3A is sent to the PC 800 in this manner, thereby facilitating using the relevant data and the specified data to edit the source data of the print data and edit the image to be printed. Furthermore, in the embodiment, the specified data having a large amount could be divided into a plurality of tags 3A for recording the resulting data. It is thus possible to successfully record the specified data on the tag 3A even when the tag 3A has a low storage capacity.

Note that in the embodiment, the processes of S2 and S52, and the display 820, the keyboard 830, and the mouse 840, which are related to the processes, correspond to a selecting unit. Additionally, the present invention is not limited to the embodiment but may also be implemented in various forms without deviating from the scope and spirit of the present invention.

For example, it may be possible to employ various types of image forming unit such as one which forms images by ejecting ink, without being limited to the one that forms images by electro-photography as in this embodiment. Furthermore, a tag which transmits and receives data using infrared rays may also be employed as a non-contact tag. Furthermore, when the printer 1 includes a control panel 220 of an appropriate size, all the processes executed by the PC 800 in the embodiment may be executed by the controller 200. In this case, the single printer 1 can form the image forming apparatus.

Furthermore, for example, a multi-function device may be equipped with a scanner (original document reader) function, a copying function, or a facsimile function in addition to the printer function. In this case, while the automatic document feeder mechanism (so-called ADF mechanism) included in the scanner function is conveying the sheet 3 attached with the tag 3A, the tag reader installed along the conveying path may read the data stored on the tag 3A.

The present invention provides illustrative, non-limiting embodiments as follows:

An image forming apparatus includes a data processing unit that processes source data to generate image data, an image forming unit that forms an image, based on the image data generated by the data processing unit, on a recording medium equipped with a non-contact tag, and a data recording unit that records data associated with the image data one the non-contact tag.

According to the above configuration, the image forming unit forms the image on the recording medium based on the image data. And, when the recording medium is equipped with the non-contact tag, the data recording unit records the data associated with the image data on the non-contact tag. Here, the data associated with the image data can be referred during browsing and editing using an application associated with the source data. Accordingly, the data associated with the image data can be read from the non-contact tag attached to the recording medium after the image has been formed thereon, thereby facilitating editing the image formed on the recording medium.

The image data may be generated from the data to be recorded on the non-contact tag.

The data associated with the image data and recorded on the non-contact tag may be selected in accordance with a user instruction. In this case, the data associated with the image data to be recorded on the non-contact tag can be selected according to the user's desire.

The data associated with the image data and recorded on the non-contact tag may include data for generating the image data.

The image formed on the recording medium may include a graph by which numerical values are visualized, and the data associated with the image data and recorded on the non-contact tag may include the numerical values. In this case, the graph formed as an image on the recording medium can be easily edited and reproduced.

The image formed on the recording medium may include a table in which numerical values are arranged in a predetermined order, and the data associated with the image data and recorded on the non-contact tag may include the numerical values. In this case, the table formed as a calculation in tabular form or tabular image on the recording medium can be easily edited and reproduced.

The data associated with the image data and recorded on the non-contact tag may include first sub-data editable by a user. In this case, referring to the first sub-data regarding the image data formed as an image on the recording medium, the image can be readily edited.

The data associated with the image data and recorded on the non-contact tag includes second sub-data which is not editable by a user. In this case, referring to the second sub-data of the image data formed as an image on the recording medium, the image can be readily edited. Note that a comment can be freely edited by the user, whereas a part of property is such data that cannot be freely edited by the user (e.g., Exif information embedded in photographic data).

The image forming apparatus may further include an acquiring unit that, when the source data includes a link to another data, acquires the other data. The data recording unit may record the other data acquired by the acquiring unit on to the non-contact tag. In this case, referring to the data linked by a link included in the source data of image data formed as an image on the recording medium, the image can be readily edited.

The data recording unit may record, on the non-contact tag, another data than the source data which is not used for generating the print data. In this case, referring to the data related by the user to the image data formed as an image on the recording medium, the image can be readily edited.

A plurality of data may be collectively specified as the other data (e.g., within the same folder). In this case, the user can provide an instruction more easily to the data.

When the source data may have been updated by a plurality of times and a plurality of versions of the source data exist, the data recording unit records at least one version of the source data together with a user-selected version of the source data from which the image data is generated, on the non-contact tag. In this case, referring to another version of the source data formed as an image on the recording medium, the image can be readily edited.

The data recording unit may record, on the non-contact tag, the user-selected version of the source data and either one of whole versions of the source data, a latest version of the source data, an oldest version of the source data, and a counter version of the source data. In this case, a desired version of the source data can be selected more easily. Note that the counter version refers to the oldest version when the image data formed as an image on the recording medium is the latest version whereas referring to the latest version when the image data formed as an image on the recording medium is the oldest version.

The data recording unit may record data located in a same location (within the same folder) as the source data. When the source data is included in a folder including a sub-folder and the sub-folder includes another data, the data recording unit may record the other data in the sub-folder on the non-contact tag. In this case, referring to the other data stored at the same location as that of the source data of image data formed as an image on the recording medium or below that location, the image can be readily edited.

When the source data is included in a folder with other data, the data recording unit may record all the data in the folder, on the non-contact tag.

When the image forming unit forms the image on a plurality of recording media and the data recording unit records a plurality of data on a plurality of non-contact tags attached to the plurality of recording media, the data recording unit may divide the plurality of data into a plurality of groups of data and records each group of data on each non-contact tag. In this case, even when the capacity of the non-contact tag is too small for storing the source data, the source data can be successfully recorded on the non-contact tag.

When the image forming unit forms the image on a plurality of recording media and the data recording unit records data on a plurality of non-contact tags attached to the plurality of recording media, the data recording unit divides the data to be recorded on the plurality of non-contact tags into a plurality of pieces of data, and records each piece of data on each non-contact tag. The data recording unit may divide the data into a plurality of pieces of data, each piece of data corresponding to an image formed on respective one of the plurality of recording media. The data recording unit may record each piece of data on the non-contact tag attached to the corresponding recording medium. In this case, the data associated with the image data formed on the respective recording media may be divided and recorded on the plurality of non-contact tags. That is, such a recording medium that is required for editing may only have to be prepared, and thus no other recording medium needs to be prepared.

A computer program product is embodied on a computer readable medium, which when executed by a computer configured to communicate with an image forming apparatus comprising an image forming unit and a data recording unit, causes the computer to perform operations. The operations include processing source data to generate image data; outputting the image data to the image forming unit which forms an image based on the image data on a recording medium equipped with a non-contact tag; and outputting data associated with the image data to the data recording unit which records the data associated with the image data on the non-contact tag.

What is claimed is:

1. An image forming apparatus comprising:
a data processing unit that processes source data to generate image data;
an image forming unit that forms an image, based on the image data generated by the data processing unit, on a recording medium equipped with a non-contact tag; and
a data recording unit that records data associated with the image data on the non-contact tag.

2. The image forming apparatus according to claim 1,
wherein the image data is generated from the data to be recorded on the non-contact tag.

3. The image forming apparatus according to claim 1,
wherein the data associated with the image data and recorded on the non-contact tag is selected in accordance with a user instruction.

4. The image forming apparatus according to claim 1,
wherein the data associated with the image data and recorded on the non-contact tag includes data for generating the image data.

5. The image forming apparatus according to claim 4,
wherein the image formed on the recording medium includes a graph by which values are visualized, and
wherein the data associated with the image data and recorded on the non-contact tag includes the values.

6. The image forming apparatus according to claim 4,
wherein the image formed on the recording medium includes a table in which values are arranged in a predetermined order, and
wherein the data associated with the image data and recorded on the non-contact tag includes the values.

7. The image forming apparatus according to claim 1,
wherein the data associated with the image data and recorded on the non-contact tag includes first sub-data editable by a user.

8. The image forming apparatus according to claim 1,
wherein the data associated with the image data and recorded on the non-contact tag includes a second sub-data which is not editable by a user.

9. The image forming apparatus according to claim 1, further comprising an acquiring unit that, when the source data includes a link to another data, acquires the other data,
wherein the data recording unit records the other data acquired by the acquiring unit, on the non-contact tag.

10. The image forming apparatus according to claim 1,
wherein the data recording unit records, on the non-contact tag, another data than the source data, and
wherein the other data is not used for generating the image data.

11. The image forming apparatus according to claim 10,
wherein a plurality of data are collectively specified as the other data.

12. The image forming apparatus according to claim 11,
wherein the plurality of data located at a same location are collectively specified as the other data.

13. The image forming apparatus according to claim 1,
wherein, when the source data has been updated by a plurality of times and a plurality of versions of the source data exist, the data recording unit records at least one version of the source data together with a user-selected version of the source data from which the image data is generated, on the non-contact tag.

14. The image forming apparatus according to claim 13,
wherein the data recording unit records, on the non-contact tag, the user-selected version of the source data and either one of
whole versions of the source data,
a latest version of the source data,
an oldest version of the source data, and
a counter version of the source data.

15. The image forming apparatus according to claim 1,
wherein the data recording unit records data located in a same location as the source data, on the non-contact tag.

16. The image forming apparatus according to claim 15,
wherein when the source data is included in a folder with other data, the data recording unit records all the data in the folder, on the non-contact tag.

17. The image forming apparatus according to claim 15,
wherein when the source data is included in a folder including a sub-folder and the sub-folder includes another data, the data recording unit records the other data in the sub-folder on the non-contact tag.

18. The image forming apparatus according to claim 1,
wherein when the image forming unit forms the image on a plurality of recording media and the data recording unit records a plurality of data on a plurality of non-contact tags attached to the plurality of recording media, the data recording unit divides the plurality of data into a plurality of groups of data and records each group of data on each non-contact tag.

19. The image forming apparatus according to claim 1,
wherein when the image forming unit forms the image on a plurality of recording media and the data recording unit records data on a plurality of non-contact tags attached to the plurality of recording media, the data recording-unit divides the data to be recorded on the plurality of non-contact tags into a plurality of pieces of data, and records each piece of data on each non-contact tag.

20. The image forming apparatus according to claim 19,
wherein the data recording unit divides the data into a plurality of pieces of data, each piece of data corresponding to an image formed on respective one of the plurality of recording media, and
wherein the data recording unit records each piece of data on the non-contact tag attached to the corresponding recording medium.

21. A computer program product embodied on a computer readable medium, which when executed by a computer configured to communicate with an image forming apparatus comprising an image forming unit and a data recording unit, causes the computer to perform operations comprising:
processing source data to generate image data;
outputting the image data to the image forming unit which forms an image based on the image data on a recording medium equipped with a non-contact tag; and
outputting data associated with the image data to the data recording unit which records the data associated with the image data on the non-contact tag.
